(19) United States
(12) Patent Application Publication
(10) Pub. No.: US 2026/0348151 A1
(43) Pub. Date: Nov. 5, 2026

(54) WEATHER BARRIER

(71) Applicant: Advanced Building Products, Inc., Sanford, ME (US)

(72) Inventor: Keith A. Lolley, Sanford, ME (US)

(21) Appl. No.: 19/329,063

(22) Filed: Sep. 15, 2025

Related U.S. Application Data
(60) Provisional application No. 63/798,671, filed on May 2, 2025.

(51) Int. Cl. E04B 1/62; B32B 5/02; B32B 7/12; E04D 5/10; E04D 5/14

(52) U.S. Cl. CPC E04B 1/625; B32B 5/028; B32B 7/12; E04D 5/10; E04D 5/148; B32B 2250/02; B32B 2250/03; B32B 2419/06

(57) ABSTRACT

In some embodiments, a weather barrier includes a membrane, an adhesive layer, an entangled net material, and a release layer. The membrane may include a first surface and a second surface opposite the first surface. The adhesive layer may be coupled to a first region of the first surface, the first region extending along a first edge of the membrane. The entangled net material may be coupled to at least a second region of the first surface different from the first region, the entangled net material being configured and arranged to form elongated channels that are oriented generally parallel to the first edge to allow liquid to flow though the elongated channels. The release layer may be releasably coupled to the adhesive layer.

### CROSS-REFERENCE TO RELATED APPLICATIONS

This application claims the benefit under 35 U.S.C. § 119(e) of U.S. Provisional Application Ser. No. 63/798,671, entitled WEATHER BARRIER, filed May 2, 2025, the entire contents of which are incorporated herein by reference for all purposes.

### BACKGROUND

The accumulation of moisture within building structures, e.g., walls, floors and roof, should be avoided in the construction industry. For example, it is commonplace to use a “house wrap” over the exterior frame and underneath the exterior veneer or cladding of a house. To improve drainage and/or ventilation within the structure and thereby minimize moisture and/or water intrusion issues, barrier products are offered. These barrier products may include a ventilation structure bonded to a weather barrier membrane. One such product is commercially available under the trade name MORTAIRVENT® rainscreen from Advanced building Product, Inc., of Sanford, ME.

### SUMMARY

In some aspects, the techniques described herein relate to a weather barrier, including: a membrane including a first surface and a second surface opposite the first surface; an adhesive layer coupled to a first region of the first surface, the first region extending along a first edge of the membrane; an entangled net material coupled to at least a second region of the first surface different from the first region, the entangled net material being configured and arranged to form elongated channels that are oriented generally parallel to the first edge to allow liquid to flow though the elongated channels; and a release layer releasably coupled to the adhesive layer.

### BRIEF DESCRIPTION OF THE DRAWINGS

FIG. 1 shows a side view of a first example weather barrier, installed between the wall sheathing and the exterior cladding of a building structure, in accordance with some embodiments of the present disclosure.

FIG. 2 shows a side view of a second example weather barrier in accordance with some embodiments of the present disclosure.

FIG. 3 shows a top view of the example weather barrier shown in FIG. 2, after the release layer has been removed.

FIG. 4 illustrates how a set of two or more example weather barriers may be coupled together, in accordance with some embodiments of the present disclosure.

FIG. 5 illustrates how two or more example weather barriers may be installed on a building structure, in accordance with some embodiments of the present disclosure.

FIG. 6 shows a side view illustrating how an example weather barrier may be installed between the roof sheathing and the shingles (or other roofing material) of a building structure, in accordance with some embodiments of the present disclosure.

FIG. 7 shows a side view of a third example weather barrier, installed between the wall sheathing and the exterior cladding of a building structure, in accordance with some embodiments of the present disclosure.

### DETAILED DESCRIPTION

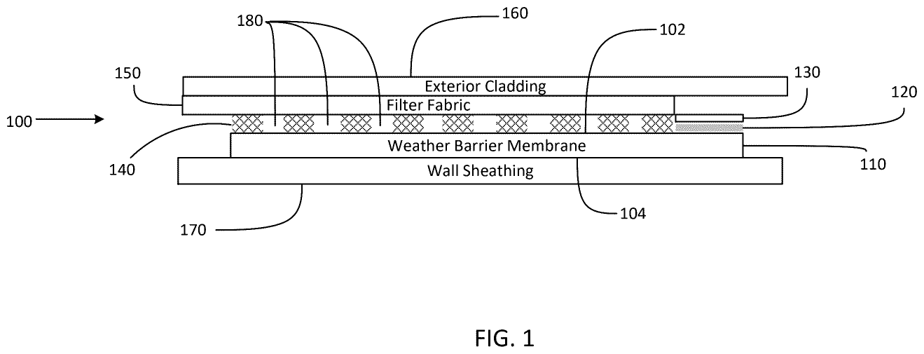

FIG. 1 shows side view of a first example weather barrier 100 configured in accordance with some embodiments of the present disclosure. In the illustrated example, the weather barrier 100 is shown as it may be installed between wall sheathing 170 and exterior cladding 160 of an exterior wall of a building. As shown, in some implementations, the weather barrier 100 may include a weather barrier membrane 110, an entangled net 140, a filter fabric layer 150, an adhesive layer 120, and a release layer 130.

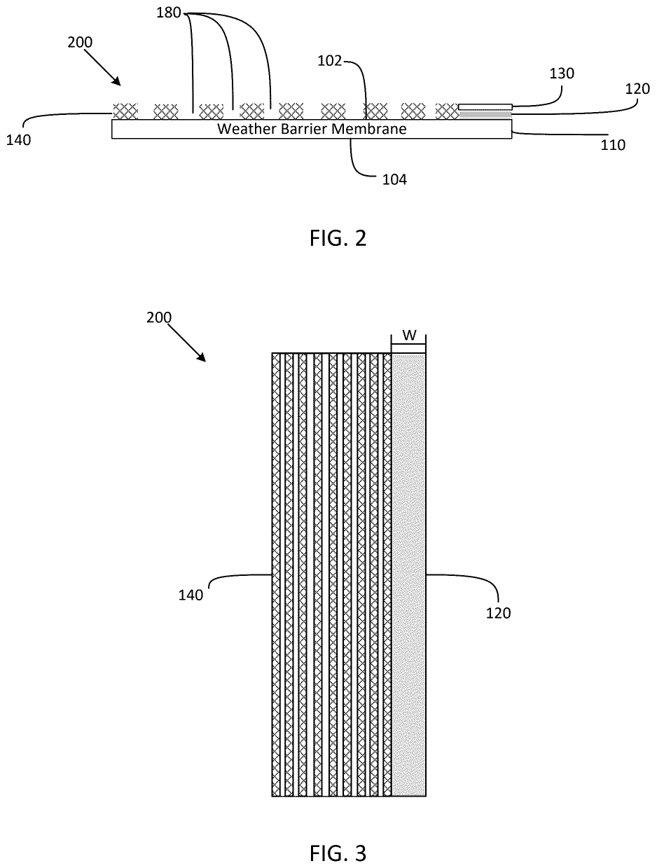

FIG. 2 shows a side view of a second example weather barrier 200 configured in accordance with some embodiments of the present disclosure. As can be seen by comparing FIGS. 1 and 2, the weather barrier 200 (shown in FIG. 2) is similar to the weather barrier 100 (shown in FIG. 1), except that it does not include the filter fabric layer 150.

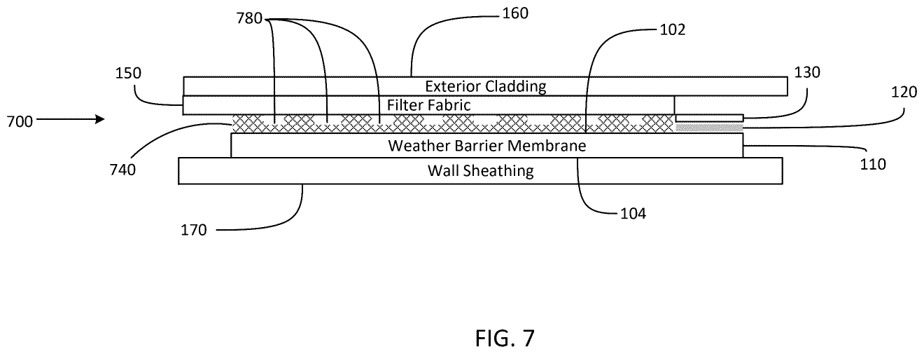

FIG. 7 shows a side view of a third example weather barrier 700 configured in accordance with some embodiments of the present disclosure. As can be seen by comparing FIGS. 1 and 7, the weather barrier 700 (shown in FIG. 7) is similar to the weather barrier 100 (shown in FIG. 1), except that weather barrier 700 has a different entangled net 740 configuration.

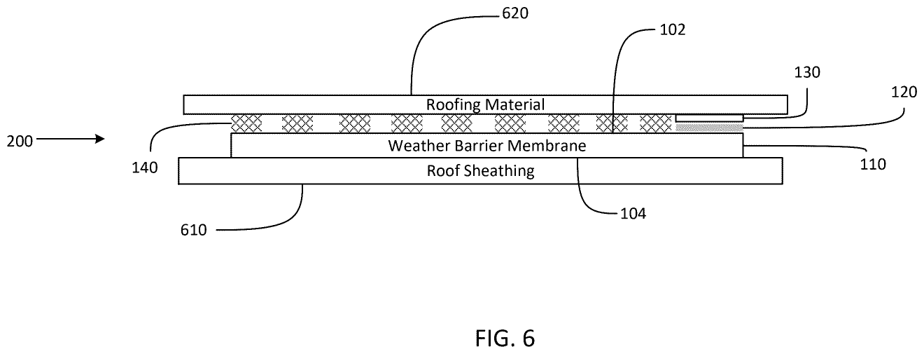

The weather barriers 100, 200, 700 may each be configured to seal moisture and/or liquid from entering a building structure. As described in more detail below, in addition to the application shown in FIGS. 1 and 7 (e.g., where the weather barrier 100 is installed between the exterior cladding 160 and the wall sheathing 170), the weather barriers 100, 200, 700 may alternatively be used for any of a number of other possible applications. For example, as described below in connection with FIG. 6, a weather barrier 100, 200, 700 may be installed on the roof of a building structure between the sheathing and shingles or other roofing material. As another example, a weather barrier 100, 200, 700 may be installed within the floor of a building structure (e.g., between the subfloor and overlaying flooring material).

As noted above (and as illustrated in FIGS. 1 and 7), in some applications, the weather barrier 100, 700 may be positioned (e.g., installed) between the exterior cladding 160 and the wall sheathing 170 of a building. In some implementations, the wall sheathing 170 may be any conventional sheathing. For example, the wall sheathing 170 may be plywood, rigid foam insultation applied over a stud frame, or a combination thereof. Although not separately illustrated, it should be appreciated that the weather barrier 200 may similarly be positioned between the exterior cladding 160 and the wall sheathing 170 of a building structure in a similar fashion.

As shown in FIGS. 1, 2 and 7, the weather barrier membrane 110 may have a first surface 102 and a second surface 104. An adhesive layer 120 may be disposed on a first region of the first surface 102 (e.g., along a long edge of the weather barrier membrane 110). A release layer 130 may be releasably attached to the adhesive layer 120. An entangled net 140, 740 may be coupled to a second region of the first surface 102 (e.g., the portion of the first surface 102 that does not include the adhesive layer 120). In some implementations (e.g., in the weather barrier 100 shown in FIG. 1 and weather barrier 700 shown in FIG. 7), a filter fabric layer 150 may be coupled to the entangled net 140, 740 opposite the weather barrier membrane 110.

The weather barrier membrane 110 may be configured to seal moisture and/or liquid from entering the building structure. The weather barrier membrane 110 may have any suitable dimensions. For example, the weather barrier membrane 110 may have a thickness between 1.5 mm to 60 mm (0.059 inches to 2.362 inches). In some implementations, the weather barrier membrane 110 may have a width between 36 inches and 48 inches (914.4 mm to 1219.2 mm). It should be appreciated that the dimensions of the weather barrier membrane 110 may be based, at least in part, on one or more local building codes and/or an application type. For example, the weather barrier membrane 110 may have a greater thickness when the weather barrier 100 is installed along a roof of a building structure (e.g., as described below in connection with FIG. 6) as opposed to a wall of a building structure.

The weather barrier membrane 110 may be made of any suitable material. In some implementations, the weather barrier membrane 110 may be vapor permeable. In some implementations, the weather barrier membrane 110 may be a film membrane or nonwoven membrane. The nonwoven membrane may be a spunbond nonwoven, meltblown nonwoven or a combination thereof. The weather barrier membrane 110 may be made of thermoplastic materials. The weather barrier membrane 110 may be a coated membrane with enhanced water resistance. As an example, the weather barrier membrane 110 may be commercially available from, for example, Magnera Corp. of Charlotte, NC, as TYPAR®. In some implementations, such as when the weather barrier 100, 200 is used in a roofing application, the weather barrier membrane 110 may be a tar paper or synthetic roofing felt (e.g., made from fiberglass fleece or polyester treated with a water proofing agent).

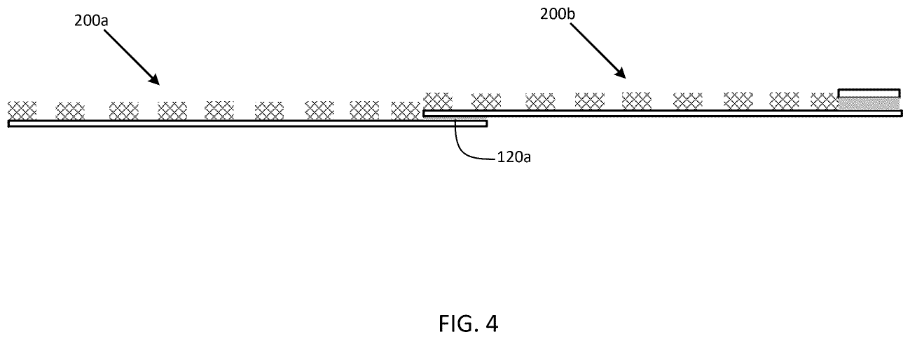

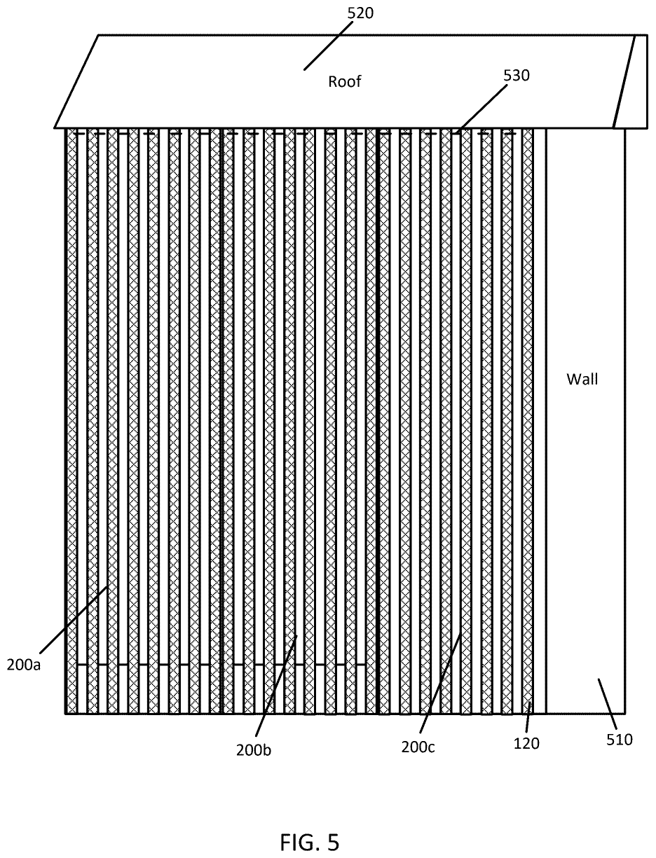

The adhesive layer 120 may be configured and arranged to allow two or more weather barriers 100, 200, 700 to be coupled together along their edges, e.g., as shown in FIGS. 4 and 5. The adhesive layer 120 may include any suitable adhesive. In some implementations, the adhesive may be a pressure sensitive adhesive. A suitable pressure sensitive adhesives may be produced, for example, using latexes synthesized via a starved seeded semi-batch emulsion polymerization process with butyl acrylate, methyl methacrylate and sometimes additional monomers, 2-hydroxy ethyl methacrylate and/or acrylic acid. In some implementations, the adhesive may be a non-asphalt acrylic adhesive.

The adhesive may be applied to form the adhesive layer 120 in any suitable shape and/or manner. For example, the adhesive may be applied as a bead, a single layer, one or more strips, splatter coated, scattered, or any combination thereof. The adhesive layer 120 may have any dimension that is suitable for coupling weather barriers 100, 200, 700 together along their edges. For example, in some implementations, the adhesive layer 120 may have a width between 4 inches and 6 inches (101.6 mm to 152.4 mm).

The release layer 130 may be configured to cover the adhesive layer 120 prior to installation. For example, the release layer 130 may block dust from sticking to and/or negatively affecting the adhesive layer 120 in order to ensure the adhesive layer 120 may join multiple weather barriers 100, 200 together effectively. The release layer 130 may include a silicone surface adjacent the adhesive layer 120 to allow for the release layer 130 to be quickly and/or easily removed. In some implementations, the release layer 130 may include just one portion configured to be removed in a single motion. In other implementations, the release layer 130 may include two or more sections which may be removed individually.

The entangled net 140, 740 may be configured to facilitate movement of moisture (e.g., liquid water) within the weather barrier 100, 700, so that such moisture may escape, for example, through drains or vents (e.g., weep holes), in a lower part of the building structure. Entangled nets are typically configured in either of two general forms: 1) a solid formed of a plurality of entangled fibers (filaments or continuous fibers); or 2) a sheet of entangled fibers (filaments or continuous fibers) where the sheet is molded or folded (e.g., forming, for example, a sine curve (or corn rows) in cross-section (also referred to as ‘channels’), or ‘peaks and furrows’ (or ‘W’)) (also referred to as ‘channels’), or dimpled or waffle (e.g., cone-shaped, pyramidal-shaped including truncated cones or pyramids). Examples of suitable structures that may be used as the entangled net 140, 740 are described, for example, U.S. Pat. Nos. 7,096,630; 8,146,310; 8,544,218; and 8,528,286, and U.S. Patent Application Publication No. US2006/0230699, the entire contents of each of which are incorporated herein by reference.

An optimal thickness of the entangled net 140, 740 may depend on the application in which the weather barrier 100, 200, 700 is to be used. For example, the entangled net 140, 740 may have a thickness of 3 mm, 6 mm, 10 mm, 20 mm, 40 mm, etc. The entangled net 140, 740 may be made of strands (large diameter filaments) extruded from a thermoplastic material including, among other materials, polyolefin (e.g., polypropylene) and/or polyamides (e.g., nylon). In general, the fibers of the entangled net 140, 740 may create an open solid (open in the sense of the interstitial spaces between the fibers). The entangled net 140, 740 may be made of thermoplastic materials. Suitable thermoplastic materials may include, for example, polypropylene, nylon (e.g., nylon 6), and/or polyethylene (e.g., HDPE).

Advantageously, in some implementations, the entangled net 140, 740 may include one or more channels 180 (as shown in FIGS. 1 and 2) or 780 (as shown in FIG. 7). It should be appreciated that the channels 180, 780 may be formed by one or more openings in the entangled net 140, 740. For example, as shown in FIG. 1, the channels 180 may be formed by a plurality of strips of entangled net 140. The channels 180 and the plurality of strips may have any suitable width. For example, the channels 180 may have a width of 1 inch, 2 inches, 3 inches, etc. Alternatively, in some implementations, the strips of the entangled net 140 may have a width of 1 inch, 2 inches, 3 inches, etc. It should be appreciated that the selected width may be based, at least in part, on the application for the weather barrier 100.

In some implementations, the channels 180 may be formed so as to extend in a direction generally parallel to the long edge of the weather barrier membrane 110 along which the adhesive layer 120 is disposed. As shown in FIG. 7, in some implementations, the channels 780 may be formed such that the entangled net 140 extends across most of the width of the weather barrier membrane 110, but includes elongated cavities corresponding to the channels 180. The channels 180, 780 may be formed vertically or horizontally depending on the orientation of installation of the weather barrier 100, 200, 700 and may form additional paths for moisture to drain through the weather barrier 100, 200, 700. In some implementations, the channels 180 may be used by the person installing the weather barrier 100, 200, 700 to ensure the weather barrier 100, 200, 700 is being oriented correctly when installed. In some implementations, the channels 180, 780 may be oriented parallel to the edge of the region of the weather barrier membrane 110 on which the adhesive layer 120 is disposed. The entangled net 140, 740 may be coupled to the weather barrier membrane 110 in any suitable manner. For example, the entangled net 140, 740 may be heat bonded to the weather barrier membrane 110, adhered to the weather barrier membrane 110 using an adhesive, etc.

In some implementations (e.g., in the weather barrier 100 shown in FIG. 1 and weather barrier 700 shown in FIG. 7), the filter fabric layer 150 may be configured to keep the entangled net 140, 740 free of obstructions. For example, when the exterior cladding 160 is constructed using mortar (e.g., masonic walls), the filter fabric layer 150 may block any mortar from obstructing the entangled net 140, 740 and/or weeps positioned at the bottom of the exterior wall (not shown). The filter fabric layer 150 may be moisture permeable so as to allow moisture (e.g., liquid water) to pass therethrough.

The filter fabric layer 150 may have any suitable thickness. For example, the filter fabric layer 150 may have a thickness of 1 mm, 2 mm, 3 mm, etc. As an example, the filter fabric layer 150 may be commercially available from, for example, Advanced Building Products Inc. of Sanford, ME as MORTAIRVENT®.

As illustrated in FIGS. 1 and 7, in some implementations, the filter fabric layer 150 may extend beyond the region of the weather barrier membrane 110 on which the entangled net 140 is disposed, so as to create a flap along an edge of the weather barrier 100, 700 opposite the edge on which the adhesive layer 120 is disposed. Such a flap may be used for any suitable purposes. For example, in some implementations, the flap may be folded along an edge of the building structure to prevent entry of bugs and/or cover a portion of the weather barrier 100, 700 positioned next to a second weather barrier 100, 700.

FIG. 3 shows a front view of an example implementation of the weather barrier 200, after the release layer 130 has been removed from the adhesive layer 120, in accordance with some implementations. As shown in FIG. 3, the adhesive layer 120 may have a width (W). The adhesive layer 120 may have any suitable width as described herein. The entangled net 140 and the adhesive layer 120 may be at least partially non-overlapping so that at least a portion of the adhesive layer 120 is exposed (e.g., for attachment to another weather barrier 100, 200, 700) after the release layer 130 has been removed. Once the release layer 130 has been removed, the adhesive layer 120 may be substantially exposed to allow a seal to be created between two weather barriers 200 when coupled together as shown in FIGS. 4 and 5. Although not depicted in the figures, it should be appreciated that the weather barrier 100, 700 (including the filter fabric layer 150) may be configured and used/installed in a similar fashion.

In some implementations, weather barriers 100, 200, 700 may include one or more marks (not shown) to indicate an orientation and/or an alignment of the weather barriers 100, 200, 700. The one or more marks may be printed on any suitable surface of the weather barrier 100, 200, 700. For instance, the one or more marks may be printed on the weather barrier membrane 110, the entangled net 140, 740, the release layer 130, the filter fabric layer 150, or any combination thereof. The one or more marks may be any suitable indication to assist a user with properly orienting a weather barrier 100, 200, 700 on a building structure and/or properly aligning two or more weather barriers 100, 200, 700 with respect to one another. The nature of the one or more marks may be based on the intended use of the weather barriers 100, 200, 700. For example, horizontal and/or vertical marks may be spaced one inch apart from one another along a length and/or width of the weather barriers 100, 200 to allow for the weather barriers 100, 200, 700 to be properly aligned for vertical installation (e.g., as described below in connection with FIG. 5). As another example, one or more marks may be spaced 16 inches or 24 inches on center to allow the weather barrier 100, 200, 700 to be properly aligned with studs of a wall or joists of a roofing structure and/or to allow the placement of one or more fasteners at the locations of such studs or joists.

FIG. 4 illustrates how a first weather barrier section 200a may be coupled to a second weather barrier section 200b, in accordance with some embodiments. As shown, the first weather barrier section 200a may be coupled to the second weather barrier section 200b along an adhesive layer 120a of the first weather barrier section 200a. The adhesive layer 120a may include a pressure sensitive adhesive which may decrease in thickness as pressure is applied. Although FIG. 4 illustrates the second weather barrier section 200b as being slightly offset from the first weather barrier section 200a, it should be appreciated that, in an actual implementation, after being coupled together, the first weather barrier section 200a and the second weather barrier section 200b may be substantially flat against a building structure (e.g., the sheathing 170). In some implementations, e.g., when installed horizontally, the first weather barrier section 200a and the second weather barrier section 200b may create a shingling effect to create a seal to keep moisture (liquid) from getting between the weather barrier sections 200a, 200b. For example, in some implementations, the second weather barrier section 200b may be installed horizontally above the first weather barrier section 200a such that the second weather barrier section 200b overlaps the first weather barrier section 200a in the manner illustrated in FIG. 4.

FIG. 5 shows an example of how multiple weather barrier sections 200a, 200b, 200c may be installed vertically on a building structure, in accordance with some implementations. The weather barrier 200 may be received as a roll and may be sectioned in prepared lengths equivalent to a height of the building structure. When being installed, a first weather barrier section 200a may be coupled to the top of a wall 510 under a roof 520 using one or more pins 530. The first weather barrier section 200a may be pinned at the top of the wall 510 and placed such that the edge of the first weather barrier section 200a aligns with an upper edge of the wall 510. A second weather barrier section 200b may then be aligned along the adhesive layer (e.g., as described in connection with FIGS. 1, 2 and 7) of the first weather barrier section 200a and pinned along a top edge of the second weather barrier section 200b. The second weather barrier section 200b may then be dropped to the bottom of the wall 510 and adhered to the first weather barrier section 200a along the adhesive layer of the first weather barrier section 200a after the release layer (e.g., as described in connection with FIGS. 1, 2 and 7) is removed from the first weather barrier section 200a. One or more additional weather barrier sections (e.g., weather barrier section 200c) may be installed in the same or substantially similar manner. The weather barrier sections 200a, 200b, 200c may be coupled to the wall in any suitable manner. For example, the pins 530 may include staples, tacks, nails, any other suitable connectors, or any combination thereof.

FIG. 6 illustrates an example of how the weather barrier 200 may be installed between roof sheathing 610 and roofing material 620 of a building structure. The roof sheathing 610 may be any conventional roof decking material. For example, the roof sheathing 610 may be plywood. The roofing material 620 may be any conventional roofing material, such as asphalt shingles, roofing tiles, etc. As noted above, in some implementations, the weather barrier membrane 110 in such implementations may include a tar paper or synthetic roofing felt (e.g., made from fiberglass fleece or polyester treated with a water proofing agent).

The following clauses describe example inventive aspects of the weather barrier and methods disclosed herein.
Clause 1. A weather barrier, comprising: a membrane including a first surface and a second surface opposite the first surface; an adhesive layer coupled to a first region of the first surface; an entangled net coupled to a second region of the first surface different from the first region; and a release layer releasably coupled to the adhesive layer.
Clause 2. The weather barrier of clause 1, wherein the first region extends along an edge of the membrane.
Clause 3. The weather barrier of clause 1 or claim 2, wherein the adhesive layer has a width less than or equal to 6 inches.
Clause 4. The weather barrier of any of clauses 1-3, wherein the adhesive layer has a width of at least 4 inches.
Clause 5. The weather barrier of any of clauses 1-4, wherein the adhesive layer has a width between 4 inches and 6 inches.
Clause 6. The weather barrier of any of clauses 1-5, wherein the membrane includes one or more evenly spaced marks on the first surface to facilitate orientation of the weather barrier.
Clause 7. The weather barrier of any of clauses 1-6, wherein the entangled net includes a channel configuration or a waffle configuration.
Clause 8. The weather barrier of any of clauses 1-7, further comprising: a filter layer coupled to the entangled net opposite the membrane.
Clause 9. The weather barrier of clause 8, wherein the filter layer is configured to block obstructions from entering the entangled net.
Clause 10. The weather barrier of clause 8 or claim 9, wherein the filter layer is moisture permeable.
Clause 11. The weather barrier of any of clauses 1-10, wherein the entangled net includes interstitial spaces configured and arranged to allow liquid to flow therethrough and oriented to allow water to flow therethrough and exit a building structure.
Clause 12. The weather barrier of any of clauses 1-11, wherein the membrane has a width of at least 36 inches.
Clause 13. The weather barrier of any of clauses 1-12, wherein the membrane has a width less than or equal to 48 inches.
Clause 14. The weather barrier of any of clauses 1-13, wherein the membrane has a width between 36 inches and 48 inches.
Clause 15. The weather barrier of any of clauses 1-14, wherein the membrane is vapor permeable.
Clause 16. The weather barrier of any of clauses 1-15, wherein the membrane is tar paper.
Clause 17. The weather barrier of any of clauses 1-15, wherein the membrane is synthetic roofing felt.
Clause 18. The weather barrier of any of clauses 1-15, wherein the adhesive layer includes a non-asphalt acrylic adhesive.
Clause 19. The weather barrier of any of clauses 1-18, wherein the weather barrier is installed between exterior cladding and wall sheathing of a building structure.
Clause 20. The weather barrier of clause 19, wherein the second surface is oriented adjacent the wall sheathing.
Clause 21. The weather barrier of any of clauses 1-18, wherein the weather barrier is installed between roofing material and roof sheathing of a building structure.
Clause 22. The weather barrier of clause 21, wherein the second surface is oriented adjacent the roof sheathing.
Clause 23. The weather barrier of any of clauses 1-18, wherein the weather barrier is installed between flooring material and a subfloor of a building structure.
Clause 24. The weather barrier of clause 23, wherein the second surface is oriented adjacent the subfloor.
Clause 25. A method for eliminating or reducing moisture within a building structure, the method comprising: fastening a first weather barrier to the building structure, the first weather barrier including: a membrane including a first surface and a second surface opposite the first surface, the second surface oriented adjacent an interior framing system of a building structure, an adhesive layer coupled to a first region of the first surface, the first region oriented along a first edge of the first weather barrier, an entangled net coupled to a second region of the first surface, and a release layer releasably coupled to the adhesive layer.
Clause 26. The method of clause 25, further comprising: removing the release layer; and fastening a second weather barrier to the first weather barrier, via the adhesive layer.
Clause 27. The method of clause 25 or 26, wherein: fastening the first weather barrier to the building structure includes fastening an end of the first weather barrier to a top of a wall of the building structure, so that a length of the first weather barrier extends vertically from the top of the wall to a bottom of the wall.
Clause 28. The method of any of clauses 25-27, wherein the first region extends along an edge of the membrane.
Clause 29. The method of any of clauses 25-28, wherein the adhesive layer has a width less than or equal to 6 inches.
Clause 30. The method of any of clauses 25-29, wherein the adhesive layer has a width of at least 4 inches.
Clause 31. The method of any of clauses 25-30, wherein the adhesive layer has a width between 4 inches and 6 inches.
Clause 32. The method of any of clauses 25-31, wherein the membrane includes one or more marks on the first surface, the method further comprises: using the marks to orient the first weather barrier or to determine placement of fasteners.
Clause 33. The method of any of clauses 25-32, wherein the entangled net includes a channel configuration or a waffle configuration.
Clause 34. The method of any of clauses 25-33, wherein the first weather barrier further comprises a filter layer coupled to the entangled net opposite the membrane.
Clause 35. The method of clause 34, wherein the filter layer is configured to block obstructions from entering the entangled net.
Clause 36. The method of clause 34 of claim 35, wherein the filter layer is moisture permeable.
Clause 37. The method of any of clauses 25-36, wherein the entangled net includes interstitial spaces configured and arranged to allow liquid to flow therethrough and oriented to allow water to flow therethrough and exit the building structure.
Clause 38. The method of any of clauses 25-37, wherein the membrane has a width of at least 36 inches.
Clause 39. The method of any of clauses 25-38, wherein the membrane has a width less than or equal to 48 inches.
Clause 40. The method of any of clauses 25-39, wherein the membrane has a width between 36 inches and 48 inches.
Clause 41. The method of any of clauses 25-40, wherein the membrane is vapor permeable.
Clause 42. The method of any of clauses 25-41, wherein the membrane is tar paper.
Clause 43. The method of any of clauses 25-42, wherein the membrane is synthetic roofing felt.
Clause 44. The method of any of clauses 25-43, wherein the adhesive layer includes a non-asphalt acrylic adhesive.
Clause 45. The method of any of clauses 25-44, wherein the interior framing system is sheathing of an exterior wall of the building structure.
Clause 46. The method of clause 45, further comprising: installing exterior wall cladding over the first weather barrier.
Clause 47. The method of any of clauses 25-44, wherein the interior framing system is sheathing of a roof of the building structure.
Clause 48. The method of clause 47, further comprising: installing roofing material over the first weather barrier.
Clause 49. The method of any of clauses 25-44, wherein the interior framing system is a subfloor of the building structure.
Clause 50. The method of clause 49, further comprising: installing flooring material over the first weather barrier.
Clause 51. A weather barrier, comprising: a membrane including a first surface and a second surface opposite the first surface; an adhesive layer coupled to a first region of the first surface, the first region extending along a first edge of the membrane; an entangled net material coupled to at least a second region of the first surface different from the first region, the entangled net material being configured and arranged to form elongated channels that are oriented generally parallel to the first edge to allow liquid to flow though the elongated channels; and a release layer releasably coupled to the adhesive layer.
Clause 52. The weather barrier of clause 51, wherein the entangled net material includes interstitial spaces configured and arranged to allow liquid to flow therethrough.
Clause 53. The weather barrier of clause 51 or clause 52, wherein the membrane includes a second edge perpendicular to the first edge, wherein a length of the first edge is greater than a length of the second edge.
Clause 54. The weather barrier of any of clauses 51-53, wherein the adhesive layer has a width less than or equal to 6 inches.
Clause 55. The weather barrier of clause 54, wherein the adhesive layer has a width of at least 4 inches.
Clause 56. The weather barrier of any of clauses 51-55, wherein the membrane includes a plurality of evenly spaced marks on the first surface to facilitate orientation of the weather barrier.
Clause 57. The weather barrier of any of clauses 51-56, further comprising: a filter layer coupled to the entangled net material opposite the membrane, wherein the filter layer is configured to block obstructions from entering the entangled net material.
Clause 58. The weather barrier of clause 57, wherein: the filter layer extends beyond the entangled net material and the membrane to form a flap along a second edge of the membrane parallel to the first edge.
Clause 59. The weather barrier of any of clauses 51-58, wherein the membrane has a width of at least 36 inches.
Clause 60. The weather barrier of clause 59, wherein the membrane has a width less than or equal to 48 inches.
Clause 61. The weather barrier of any of clauses 51-60, wherein: the weather barrier is installed between exterior cladding and wall sheathing of a building structure, and the second surface is oriented adjacent the wall sheathing.
Clause 62. The weather barrier of any of clauses 51-60, wherein: the weather barrier is installed between roofing material and roof sheathing of a building structure, and the second surface is oriented adjacent the roof sheathing.
Clause 63. The weather barrier of any of clauses 51-60, wherein: the weather barrier is installed between flooring material and a subfloor of a building structure, and the second surface is oriented adjacent the subfloor.
Clause 64. A method for eliminating or reducing moisture within a building structure, the method comprising: fastening the weather barrier of any clauses 51-60 to the building structure.
Clause 65. The method of clause 64, further comprising: removing the release layer from the adhesive layer; and fastening a second weather barrier to the weather barrier, via the adhesive layer.
Clause 66. The method of clause 64 or clause 65, wherein: fastening the weather barrier to the building structure includes fastening an end of the weather barrier to an upper portion of a wall of the building structure, so that the first edge of the membrane extends vertically from the upper portion of the wall to a lower portion of the wall.
Clause 67. The method of any of clauses 64-66, wherein: fastening the weather barrier to the building structure includes fastening the weather barrier to sheathing of an exterior wall of the building structure; and the method further comprises installing exterior wall cladding over the weather barrier.
Clause 68. The method of any of clauses 64-66, wherein: fastening the weather barrier to the building structure includes fastening the weather barrier to sheathing of a roof of the building structure: and the method further comprises installing roofing material over the weather barrier.
Clause 69. The method of any of clauses 64-66, wherein fastening the weather barrier to the building structure includes fastening the weather barrier to a subfloor of the building structure; and the method further comprises installing flooring material over the weather barrier.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

Various aspects of the present disclosure may be used alone, in combination, or in a variety of arrangements not specifically discussed in the embodiments described in the foregoing and is therefore not limited in this application to the details and arrangement of components set forth in the foregoing description or illustrated in the drawings. For example, aspects described in one embodiment may be combined in any manner with aspects described in other embodiments.

Also, the disclosed aspects may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence or order of one claim element over another or the temporal order in which acts of a method are performed, but are used merely as labels to distinguish one claimed element having a certain name from another element having a same name (but for use of the ordinal term) to distinguish the claim elements.

Also, the phraseology and terminology used herein is used for the purpose of description and should not be regarded as limiting. The use of “including,” “comprising,” or “having,” “containing,” “involving,” and variations thereof herein, is meant to encompass the items listed thereafter and equivalents thereof as well as additional items.

1. A weather barrier installed between exterior cladding and wall sheathing of a building structure, between roofing material and roof sheathing of the building structure, or between flooring material and a subfloor of the building structure, comprising:
a membrane including a first surface and a second surface opposite the first surface, wherein the second surface is oriented adjacent the wall sheathing, the roof sheathing, or the subfloor;
an adhesive layer coupled to a first region of the first surface, the first region extending along a first edge of the membrane;
an entangled net material coupled to at least a second region of the first surface different from the first region, the entangled net material being configured and arranged to form elongated channels that are oriented generally parallel to the first edge to allow liquid to flow through the elongated channels; and
a release layer releasably coupled to the adhesive layer.

2. The weather barrier of claim 1, wherein the entangled net material includes interstitial spaces configured and arranged to allow liquid to flow therethrough.

3. The weather barrier of claim 1, wherein the membrane includes a second edge perpendicular to the first edge, wherein a length of the first edge is greater than a length of the second edge.

4. The weather barrier of claim 1, wherein the adhesive layer has a width less than or equal to 6 inches.

5. The weather barrier of claim 4, wherein the adhesive layer has a width of at least 4 inches.

6. The weather barrier of claim 1, wherein the membrane includes a plurality of evenly spaced marks on the first surface to facilitate orientation of the weather barrier.

7. The weather barrier of claim 1, further comprising:
a filter layer coupled to the entangled net material opposite the membrane, wherein the filter layer is configured to block obstructions from entering the entangled net material.

8. The weather barrier of claim 7, wherein:
the filter layer extends beyond the entangled net material and the membrane to form a flap along a second edge of the membrane parallel to the first edge.

9. The weather barrier of claim 1, wherein the membrane has a width of at least 36 inches.

10. The weather barrier of claim 9, wherein the membrane has a width less than or equal to 48 inches.

11. The weather barrier of claim 1, wherein:
the weather barrier is installed between the exterior cladding and the wall sheathing of the building structure, and
the second surface is oriented adjacent the wall sheathing.

12. The weather barrier of claim 1, wherein:
the weather barrier is installed between the roofing material and the roof sheathing of the building structure, and
the second surface is oriented adjacent the roof sheathing.

13. The weather barrier of claim 1, wherein:
the weather barrier is installed between the flooring material and the subfloor of the building structure, and
the second surface is oriented adjacent the subfloor.

14. A method for eliminating or reducing moisture within the building structure, the method comprising:
fastening the weather barrier of claim 1 to the building structure.

15. The method of claim 14, further comprising:
removing the release layer from the adhesive layer; and
fastening a second weather barrier to the weather barrier, via the adhesive layer.

16. The method of claim 14, wherein:
fastening the weather barrier to the building structure includes fastening an end of the weather barrier to an upper portion of a wall of the building structure, so that the first edge of the membrane extends vertically from the upper portion of the wall to a lower portion of the wall.

17. The method of claim 14, wherein:
fastening the weather barrier to the building structure includes fastening the weather barrier to the wall sheathing of the building structure; and
the method further comprises installing the exterior cladding over the weather barrier.

18. The method of claim 14, wherein:
fastening the weather barrier to the building structure includes fastening the weather barrier to the roof sheathing of the building structure; and
the method further comprises installing the roofing material over the weather barrier.

19. The method of claim 14, wherein:
fastening the weather barrier to the building structure includes fastening the weather barrier to the subfloor of the building structure; and
the method further comprises installing the flooring material over the weather barrier.
